(19) United States
(12) Patent Application Publication
(10) Pub. No.: US 2026/0264497 A1
(43) Pub. Date: Sep. 10, 2026

(54) VEHICLE

(71) Applicant: TOYOTA JIDOSHA KABUSHIKI KAISHA, Toyota-shi (JP)

(72) Inventor: Nobuyasu NISHIKI, Toyokawa-shi (JP)

(73) Assignee: TOYOTA JIDOSHA KABUSHIKI KAISHA, Toyota-shi (JP)

(21) Appl. No.: 19/449,910

(22) Filed: Jan. 15, 2026

(30) Foreign Application Priority Data
Mar. 10, 2025 (JP) 2025-037073

(51) Int. Cl. B60K 1/04; B60L 50/64; H01M 50/249; H01M 50/262; H01M 50/271; H01M 50/358

(52) U.S. Cl. CPC B60K 1/04; B60L 50/64; H01M 50/249; H01M 50/262; H01M 50/271; H01M 50/358; B60L 2270/12; H01M 2220/20

(57) ABSTRACT

A vehicle includes a power storage device and an exhaust pipe, in which the power storage device includes an accommodation case and a seal member that seals a joint portion between an upper cover and a lower casing, the accommodation case includes a front wall portion and a rear wall portion, and a first side wall portion and a second side wall portion, and the exhaust pipe is disposed adjacent to the second side wall portion. The vehicle further includes a flow path defining portion that is provided outside of the accommodation case and that defines a flow path that extends along a portion of the joint portion positioned on a front wall portion side and that has an air inlet portion and an air outlet portion, and the air inlet portion is positioned at a position farther from the exhaust pipe than the air outlet portion.

### CROSS-REFERENCE TO RELATED APPLICATION

This application claims priority to Japanese Patent Application No. 2025-037073 filed on Mar. 10, 2025. The disclosure of the above-identified application, including the specification, drawings, and claims, is incorporated by reference herein in its entirety.

### BACKGROUND

### 1. Technical Field

The present disclosure relates to a vehicle.

### 2. Description of Related Art

Japanese Unexamined Patent Publication No. 2019-123366 (JP 2019-123366 A) discloses a vehicle in which a fan is installed downstream of a battery inside an accommodation case. In the vehicle, at least a part of an exhaust pipe is positioned within a projection region of an intake port of the fan projected along a rotation axis of the fan, and the intake port of the fan faces the exhaust pipe.

### SUMMARY

In the vehicle disclosed in JP 2019-123366 A, the fan is installed downstream of the battery, and the intake port of the fan is disposed to overlap the exhaust pipe. As a result, air that has cooled the battery and air within the accommodation case that has been warmed by heat from the exhaust pipe can be drawn in through the intake port and discharged to the outside of the accommodation case.

However, in a case where the exhaust pipe is disposed on a side of the accommodation case, when no measures are taken, a peripheral temperature of the accommodation case rises due to heat from the exhaust pipe, and the accommodation case is heated. In addition, a seal member that seals between an upper cover and a lower casing is likely to be affected by heat.

The present disclosure provides a vehicle in which, in a configuration in which an exhaust pipe is disposed on a side of a power storage device, a peripheral temperature of an accommodation case of the power storage device can be reduced.

A vehicle according to the present disclosure includes:
a power storage device; and
an exhaust pipe that extends along a vehicle front-rear direction, a part of the exhaust pipe being disposed on a side of the power storage device.
   The power storage device includes an accommodation case including an upper cover and a lower casing, and a seal member configured to seal a joint portion between the upper cover and the lower casing.
   The accommodation case includes a front wall portion and a rear wall portion that are spaced apart from each other in the vehicle front-rear direction, and a first side wall portion and a second side wall portion that are spaced apart from each other in a vehicle width direction.
   The exhaust pipe is disposed on the second side wall portion side.
   The vehicle further includes a flow path defining portion provided outside the accommodation case, the flow path defining portion being configured to define a flow path that extends along a portion of the joint portion positioned on the front wall portion side and that has an air inlet portion and an air outlet portion.
   The air inlet portion is positioned at a position farther from the exhaust pipe than the air outlet portion.

In the vehicle according to the present disclosure,
a connector block may be provided on the lower casing side of the front wall portion.
   The connector block may be provided with a facing portion that protrudes upward from the portion of the joint portion positioned on the front wall portion side and that faces the front wall portion in the vehicle front-rear direction.
   The flow path defining portion may include a first plate portion that is configured to connect the facing portion and the upper cover, and that covers a space between the facing portion and the front wall portion, and the facing portion.
   In this case, a region surrounded by the first plate portion, the facing portion, and the front wall portion facing the facing portion may serve as the flow path.

In the vehicle according to the present disclosure,
a facing member that protrudes upward from the portion of the joint portion positioned on the front wall portion side and that faces the front wall portion in the vehicle front-rear direction may be provided on a front surface of the lower casing.
   The flow path defining portion may include a first plate portion that is configured to connect the facing member and the upper cover, and that covers a space between the facing member and the front wall portion, and the facing member.
   In this case, a region surrounded by the first plate portion, the facing member, and the front wall portion facing the facing member may serve as the flow path.

The vehicle according to the present disclosure may include a floor panel.

The power storage device may be disposed below the floor panel.
The vehicle may further include a duct configured to take in air flowing toward a lower side of the power storage device into the flow path.

In the vehicle according to the present disclosure,
the front wall portion may include a recessed portion recessed rearward on the second side wall portion side.
   The exhaust pipe may include a first extending portion that extends along the recessed portion in the vehicle width direction, and a second extending portion that is connected to the first extending portion and extends rearward of the vehicle along the second side wall portion.
   The flow path defining portion may further include a heater insulator that is disposed between the first extending portion and the recessed portion and that faces the recessed portion from a front side of the vehicle, and a second plate portion configured to connect the heater insulator and the upper cover, and covers a space between the heater insulator and the recessed portion.
   A region surrounded by the second plate portion, the heater insulator, and the recessed portion may serve as the flow path.

In the vehicle according to the present disclosure,
the flow path defining portion may be constituted by a tubular member disposed forward of the accommodation case.

According to the present disclosure, it is possible to provide a vehicle in which, in a configuration in which an exhaust pipe is disposed on a side of a power storage device, a peripheral temperature of an accommodation case of the power storage device can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic plan view showing a positional relationship between a power storage device and an exhaust pipe in a vehicle according to Embodiment 1;

FIG. 2 is a view of the power storage device disposed below a floor panel as viewed from a side in the vehicle according to Embodiment 1;

FIG. 3 is a perspective view of a structure of the power storage device on a front wall portion side as viewed from above in the vehicle according to Embodiment 1;

FIG. 4 is a schematic cross-sectional view taken along a line IV-IV in FIG. 3;

FIG. 5 is a schematic cross-sectional view taken along a line V-V in FIG. 3;

FIG. 6 is a perspective view of the structure of the power storage device on the front wall portion side as viewed from below in the vehicle according to Embodiment 1;

FIG. 7 is a schematic cross-sectional view taken along a line VII-VII in FIG. 3;

FIG. 8 is a schematic cross-sectional view for describing a structure of a heater insulator according to Modification 1;

FIG. 9 is a schematic cross-sectional view showing a structure of an accommodation case of the power storage device on a front surface side in the vehicle according to Embodiment 2;

FIG. 10A is a view showing a variation of a flow path defining portion disposed forward of the power storage device in the vehicle according to Embodiment 3;

FIG. 10B is a view showing a variation of the flow path defining portion disposed forward of the power storage device in the vehicle according to Embodiment 3;

FIG. 10C is a view showing a variation of the flow path defining portion disposed forward of the power storage device in the vehicle according to Embodiment 3;

FIG. 10D is a view showing a variation of the flow path defining portion disposed forward of the power storage device in the vehicle according to Embodiment 3;

FIG. 10E is a view showing a variation of the flow path defining portion disposed forward of the power storage device in the vehicle according to Embodiment 3; and

FIG. 10F is a view showing a variation of the flow path defining portion disposed forward of the power storage device in the vehicle according to Embodiment 3.

### DETAILED DESCRIPTION OF EMBODIMENTS

Hereinafter, embodiments of the present disclosure will be described in detail with reference to the drawings. In the following embodiments, the same or common parts are designated by the same reference numerals in the drawings, and the description thereof will not be repeated.

### Embodiment 1

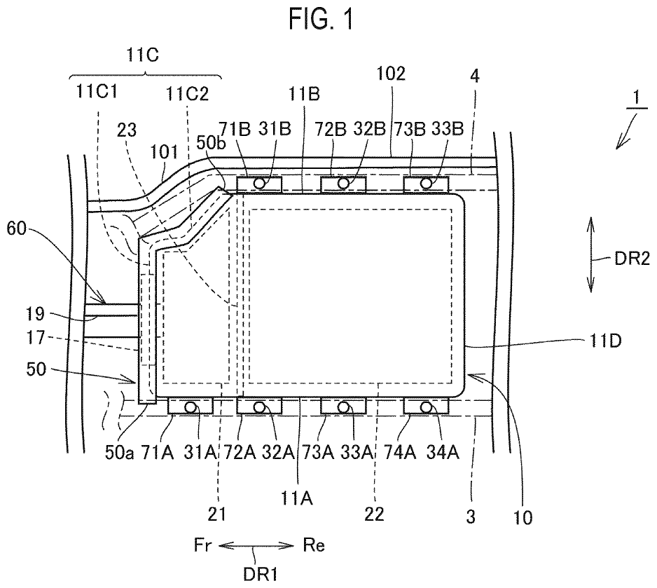

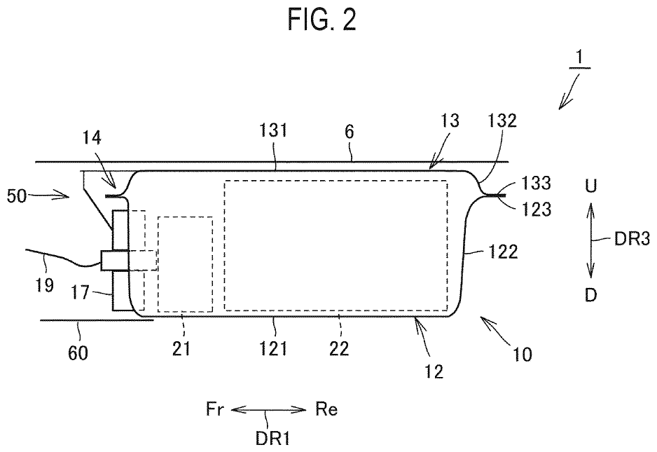

FIG. 1 is a schematic plan view showing a positional relationship between a power storage device and an exhaust pipe in a vehicle according to Embodiment 1. FIG. 2 is a view of the power storage device disposed below a floor panel as viewed from a side in the vehicle according to Embodiment 1. A vehicle 1 according to Embodiment 1 will be described with reference to FIGS. 1 and 2.

The vehicle 1 is, for example, a hybrid electric vehicle, a plug-in hybrid electric vehicle, or a battery electric vehicle.

The vehicle 1 includes a vehicle main body, a power storage device 10, an exhaust pipe 100, a vehicle wire harness 19, a plurality of first fastening portions 31A to 34A, a plurality of second fastening portions 31B to 33B, a flow path defining portion 50, and a protective plate 60.

The vehicle main body includes a first member 3, a second member 4, and a floor panel 6. The first member 3 and the second member 4 are frame members that constitute a frame of the vehicle. The first member 3 and the second member 4 extend along a vehicle front-rear direction (DR1 direction). The first member 3 and the second member 4 are disposed with a space therebetween in a vehicle width direction (DR2 direction). The first member 3 is positioned on one side in the vehicle width direction, and the second member 4 is positioned on the other side in the vehicle width direction. When viewed from above, the second member 4 is disposed between the exhaust pipe 100 and a second side wall portion 11B described below. The power storage device 10 is fixed to the first member 3 and the second member 4. The fixing of the power storage device 10 is not limited to the above.

The power storage device 10 and the exhaust pipe 100 are disposed below the floor panel 6. One end side of the vehicle wire harness 19 connected to the power storage device 10 is also disposed below the floor panel 6.

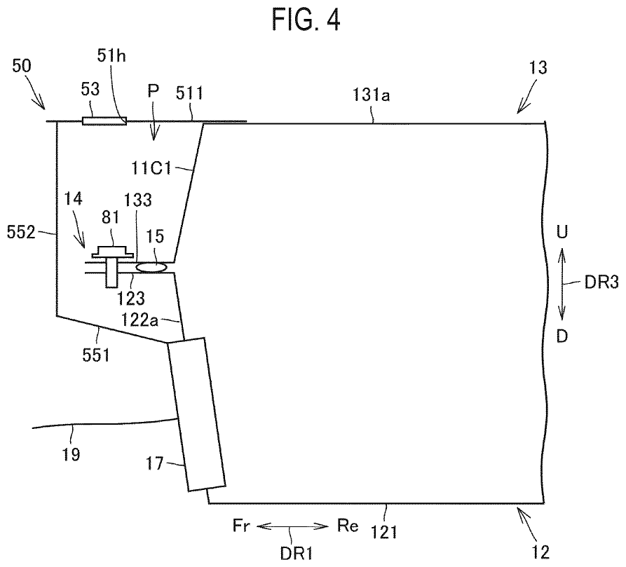

The power storage device 10 includes an accommodation case, a seal member 15 (see FIG. 4), an electric device 21, a power storage module 22, and a plurality of to-be-fixed portions 71A to 74A, 71B to 73B. The accommodation case accommodates the electric device 21 and the power storage module 22 inside. The accommodation case includes an upper cover 13 and a lower casing 12.

The upper cover 13 has a box shape that opens downward. The upper cover 13 includes a top plate portion 131, a peripheral wall portion 132, and a flange portion 133. The top plate portion 131 serves as an upper wall of the accommodation case. The peripheral wall portion 132 extends downward from a peripheral edge of the top plate portion 131. The flange portion 133 extends outward from a lower end of the peripheral wall portion 132 to the outside of the accommodation case. The upper cover 13 may have a lid shape in which the peripheral wall portion 132 is not provided.

The lower casing 12 has a box shape that opens upward. The lower casing 12 includes a bottom plate portion 121, a peripheral wall portion 122, and a flange portion 123. The bottom plate portion 121 faces the top plate portion 131 in a vertical direction. The vertical direction is parallel to a vehicle up-down direction (DR3). The peripheral wall portion 122 extends upward from a peripheral edge of the bottom plate portion 121. The flange portion 123 extends outward from an upper end of the peripheral wall portion 122 to the outside of the accommodation case.

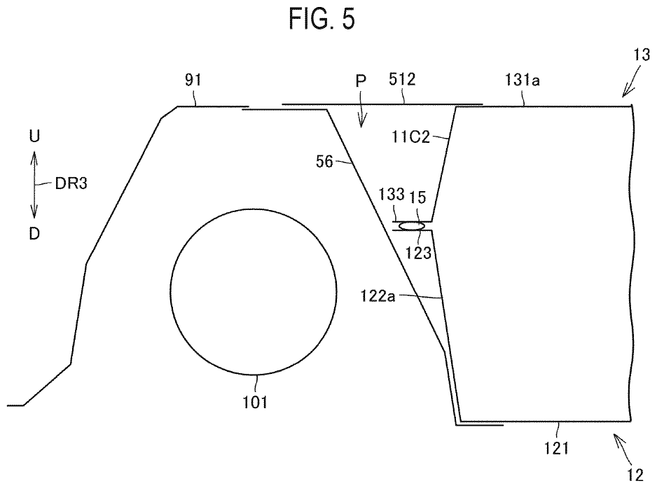

The flange portion 133 and the flange portion 123 are fastened together by a plurality of fastening members 81 (see FIG. 5) in a state of being overlapped with each other in the up-down direction. As a result, the upper cover 13 and the lower casing 12 are integrally joined to each other and provide a space for accommodating the electric device 21 and the power storage module 22 inside. A portion where the flange portion 133 and the flange portion 123 overlap each other is a joint portion 14 between the upper cover 13 and the lower casing 12. In addition, a seal member 15 (see FIG. 5) that seals the joint portion 14 is disposed between the flange portion 133 and the flange portion 123.

A partition member 23 is provided in the lower casing 12. The partition member 23 partitions a region where the electric device 21 is disposed and a region where the power storage module 22 is disposed. The partition member 23, for example, partitions the inside of the accommodation case into a front side and a rear side. In the accommodation case, the electric device 21 is disposed on the front side, and the power storage module 22 is disposed on the rear side.

The electric device 21 is, for example, a junction box. The power storage module 22 includes a plurality of power storage stacks. Each of the power storage stacks is constituted by arranging a plurality of power storage cells. The power storage cell is a secondary battery such as a nickel-hydrogen battery or a lithium-ion battery. The power storage cell may use a liquid electrolyte or may use a solid electrolyte. The power storage cell may be a chargeable and dischargeable capacitor.

The accommodation case includes a first side wall portion 11A, a second side wall portion 11B, a front wall portion 11C, and a rear wall portion 11D. The first side wall portion 11A and the second side wall portion 11B are disposed with a space therebetween in the vehicle width direction. The first side wall portion 11A is positioned on one side in the vehicle width direction. The first side wall portion 11A is substantially parallel to the vehicle front-rear direction.

The to-be-fixed portions 71A to 74A are provided in the first side wall portion 11A. The to-be-fixed portions 71A to 74A are disposed with a space therebetween in the vehicle front-rear direction. The to-be-fixed portions 71A to 74A are fixed to the first member 3 by fastening members such as bolts and nuts, and the first fastening portions 31A to 34A are provided at fastening positions of the to-be-fixed portions. The to-be-fixed portions 71A to 74A are constituted by, for example, a metal plate.

The second side wall portion 11B is positioned on the other side in the vehicle width direction. A front end position of the second side wall portion 11B is positioned rearward of the vehicle with respect to a front end position of the first side wall portion 11A.

The to-be-fixed portions 71B to 73B are provided in the second side wall portion 11B. The to-be-fixed portions 71B to 73B are disposed with a space therebetween in the vehicle front-rear direction. The to-be-fixed portions 71B to 73B are fixed to the second member 4 by fastening members such as bolts and nuts, and the second fastening portions 31B to 33B are provided at fastening positions of the to-be-fixed portions. The to-be-fixed portions 71B to 73B are constituted by, for example, a metal plate.

The front wall portion 11C and the rear wall portion 11D are disposed with a space therebetween in the front-rear direction. The front wall portion 11C connects front ends of the first side wall portion 11A and the second side wall portion 11B. The front wall portion 11C includes a first portion 11C1 that extends along the vehicle width direction, and a recessed portion 11C2 recessed rearward on a second side wall portion 11B side. The recessed portion 11C2 is connected to a front end of the second side wall portion 11B. The recessed portion 11C2 is provided to extend toward the second side wall portion 11B as the recessed portion 11C2 extends rearward. The rear wall portion 11D connects rear ends of the first side wall portion 11A and the second side wall portion 11B.

A connector block 17 is provided on a lower casing 12 side of the front wall portion 11C. For example, a wire harness 90 on the vehicle side is connected to the connector block 17. The connector block 17 is positioned below the joint portion 14.

The connector block 17 is constituted by, for example, a metal member such as aluminum. The connector block 17 is integrally made from the same material. Specifically, the connector block 17 is manufactured by die casting. When the lower casing 12 is manufactured by die casting, the lower casing 12 and the connector block 17 may be integrally molded.

The exhaust pipe 100 extends along the vehicle front-rear direction. A part of the exhaust pipe 100 is disposed on a side of the power storage device 10.

The exhaust pipe 100 includes a first extending portion 101 and a second extending portion 102. The first extending portion 101 extends in the width direction along the recessed portion 11C2. A gap is provided between the first extending portion 101 and the recessed portion 11C2. The first extending portion 101 extends toward the other side in the vehicle width direction as the first extending portion 101 extends rearward of the vehicle.

The second extending portion 102 is connected to the first extending portion 101 and extends rearward of the vehicle along the second side wall portion 11B. The second extending portion 102 is disposed adjacent to the second side wall portion 11B in the vehicle width direction. A gap is provided between the second extending portion 102 and the second side wall portion 11B. The to-be-fixed portions 71B to 73B described above are positioned in the gap.

The flow path defining portion 50 is provided outside the accommodation case and extends along a portion of the joint portion 14 positioned on a front wall portion 11C side. The flow path defining portion 50 is a portion to define a flow path P (see FIG. 5) having an air inlet portion 50a and an air outlet portion 50b. The air inlet portion 50a is positioned at a position farther from the exhaust pipe 100 than the air outlet portion 50b. Specifically, the air inlet portion 50a is positioned on the first side wall portion 11A side, and the air outlet portion 50b is positioned on the second side wall portion 11B side.

The protective plate 60 is disposed below the vehicle wire harness 19. The protective plate 60 protects the vehicle wire harness 19. A rear end of the protective plate 60 is fixed to a lower surface of the accommodation case (the lower surface of the lower casing 12). The protective plate 60 extends along the vehicle front-rear direction.

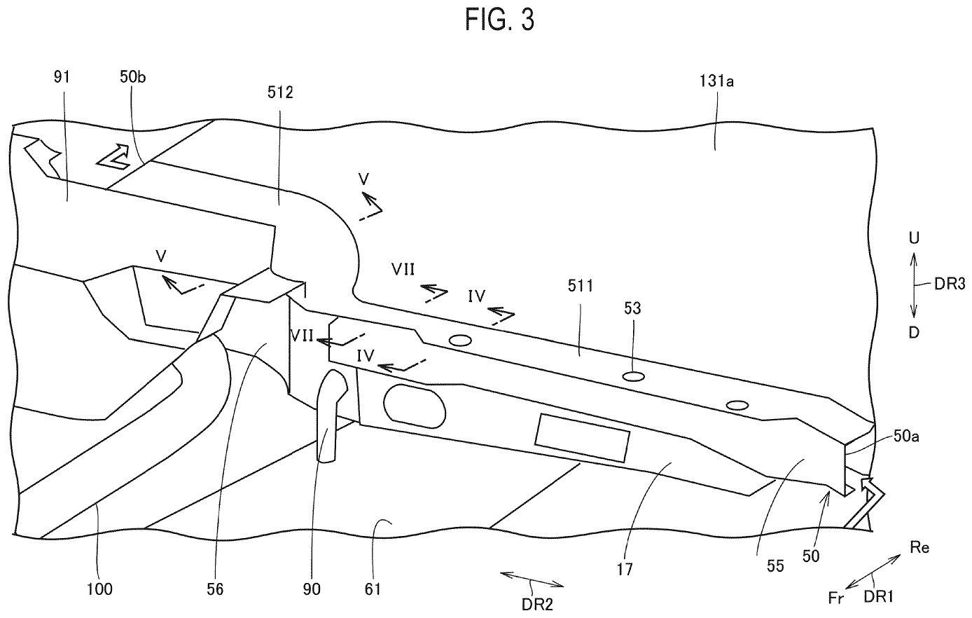

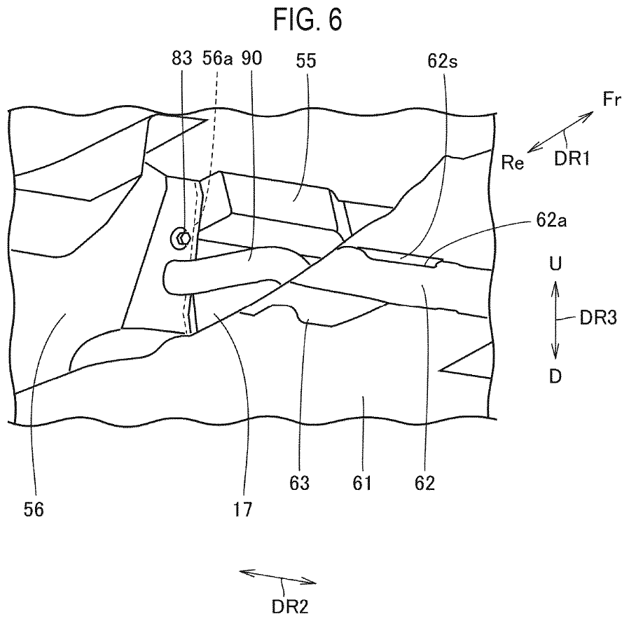

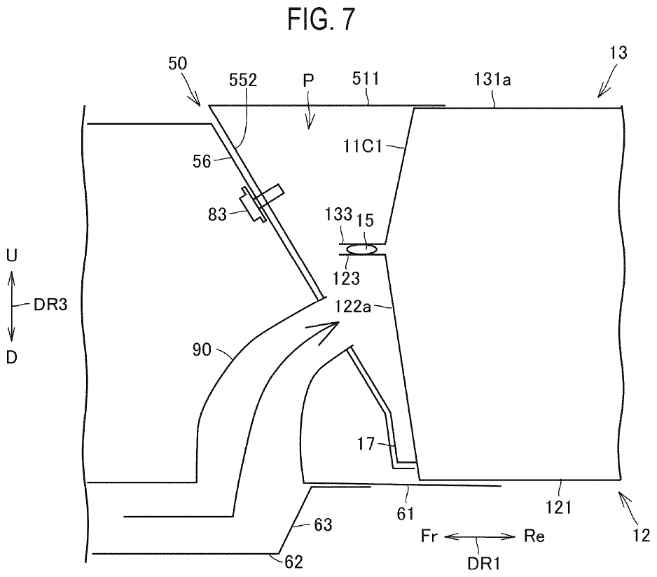

FIG. 3 is a perspective view of a structure of the power storage device on a front wall portion side as viewed from above in the vehicle according to Embodiment 1. FIG. 4 is a schematic cross-sectional view taken along a line IV-IV in FIG. 3. FIG. 5 is a schematic cross-sectional view taken along a line V-V in FIG. 3. FIG. 6 is a perspective view of the structure of the power storage device on the front wall portion side as viewed from below in the vehicle according to Embodiment 1. FIG. 7 is a schematic cross-sectional view taken along a line VII-VII in FIG. 3. In FIG. 3, for convenience, the protective plate 60 is omitted.

As shown in FIGS. 3 to 5, the flow path defining portion 50 is disposed to surround a portion of the joint portion 14 positioned on the front wall portion 11C side. The flow path defining portion 50 extends along the vehicle width direction by the front wall portion 11C.

The flow path defining portion 50 includes a facing portion 55 provided in the connector block 17 described below, a plate, and a heater insulator 56. The connector block 17 is provided on the first portion 11C1 and extends widely along the vehicle width direction. The connector block 17 is provided across the first portion 11C1, from one end side of the first portion 11C1 positioned on one side in the vehicle width direction to the other end side of the first portion 11C1 positioned on the other side in the vehicle width direction.

The facing portion 55 is disposed along the first portion 11C1 of the front wall portion 11C. The heater insulator 56 is disposed along the recessed portion 11C2 of the front wall portion 11C. The heater insulator 56 is connected to the facing portion 55, so that the heater insulator 56 and the facing portion 55 continuously face the front wall portion 11C in the vehicle width direction.

The plate extends forward from an upper surface 131a of the upper cover 13. The plate connects the upper cover 13 to the facing portion 55 and the heater insulator 56. The plate includes a first plate portion 511 and a second plate portion 512. The first plate portion 511 connects the facing portion 55 and the upper cover 13 and covers a space between the facing portion 55 and the front wall portion 11C (more specifically, the first portion 11C1). The second plate portion 512 connects the heater insulator 56 and the upper cover 13 and covers a space between the heater insulator 56 and the recessed portion 11C2.

As shown in FIG. 4, the connector block 17 includes the facing portion 55 that protrudes upward from a portion of the joint portion 14 positioned on the front wall portion 11C side and that faces the front wall portion 11C in the vehicle front-rear direction. The connector block 17 and the facing portion 55 may be configured to be separate from each other or may be integrally configured by die casting or the like.

The facing portion 55 includes a first portion 551 and a second portion 552. The first portion 551 is connected to the connector block 17 and extends upward as the first portion 551 extends forward from the front wall portion 11C. The second portion 552 extends upward from a front end of the first portion 551.

A lower side of a space positioned between the second portion 552 and the first portion 11C1 is closed by the first portion 551 and an upper portion of the connector block 17. An upper side of the space positioned between the second portion 552 and the first portion 11C1 is closed by the first plate portion 511.

A region surrounded by the first plate portion 511, the facing portion 55, and the front wall portion 11C (more specifically, the first portion 11C1) facing the facing portion 55 serves as a part of the flow path P. By defining the flow path P with such a configuration, the configuration of the flow path P can be simplified. In particular, by integrally molding the facing portion 55 and the connector block 17, the number of components can be reduced.

In addition, a plurality of opening portions 51h is provided in the plate. The opening portions 51h are provided above the fastening member 81 provided in the joint portion 14. As a result, the fastening member 81 can be inserted through the opening portion 51h to fasten and fix the flange portion 133 of the upper cover 13 and the flange portion 123 of the lower casing 12. Each of the opening portions 51h is sealed by a sealing member 53.

As shown in FIG. 5, the heater insulator 56 is disposed between the first extending portion 101 and the recessed portion 11C2 and faces the recessed portion 11C2 from a front side. A lower side of the heater insulator 56 is fixed to a bottom surface of the lower casing 12. The heater insulator 56 has a shape that extends upward as the heater insulator 56 extends toward the front side from the bottom surface of the lower casing 12. A space is provided between an upper side of the heater insulator 56 and the recessed portion 11C2. The space is closed by the second plate portion 512.

A region surrounded by the second plate portion 512, the heater insulator 56, and the recessed portion 11C2 serves as a part of the flow path P. By defining the flow path P with such a configuration, the configuration of the flow path P can be simplified. In particular, by using the heater insulator 56 disposed between the exhaust pipe 100 and the accommodation case as the flow path defining portion 50, the number of components can be reduced.

The vehicle 1 includes an exhaust pipe cover member 91 that covers the first extending portion 101 from a side opposite to the side on which the heater insulator 56 is positioned with respect to the first extending portion 101 of the exhaust pipe 100.

As shown in FIGS. 3, 6, and 7, the protective plate 60 includes a main panel 61, a sub-panel 62, and a wind direction plate 63. The main panel 61 is fixed to the lower surface of the lower casing 12 and extends forward from the lower surface of the lower casing 12. The sub-panel 62 is fixed below the main panel 61. The sub-panel 62 covers a part of the main panel 61 from a lower side. A front end 62a of the sub-panel 62 is positioned forward of the flow path defining portion 50 (more specifically, the facing portion 55). The sub-panel 62 has a protruding portion that protrudes downward, and a space 62s is provided between the protruding portion and the main panel 61. The space 62s is open toward the front side, allowing air to be introduced. The wind direction plate 63 is disposed at a rear portion of the sub-panel 62. The wind direction plate 63 guides wind entering the space 62s to a duct 90 described below.

An end portion 56a of the heater insulator 56 positioned on one side in the vehicle width direction covers end portions of the connector block 17 and the facing portion 55 positioned on the other side in the vehicle width direction. The end portion 56a of the heater insulator 56 is folded back toward the rear side of the vehicle. A folded portion of the heater insulator 56 covers outer surfaces of the connector block 17 and the facing portion 55. As a result, it is possible to suppress air leakage through a gap between the heater insulator 56 and the connector block 17.

An end portion of the heater insulator 56 that overlaps in the vehicle front-rear direction and end portions of the connector block 17 and the facing portion 55 are fastened by a fastening member 83.

The vehicle 1 further includes a duct 90 that takes in air flowing toward the lower side of the power storage device 10 into the flow path P. The duct 90 has a shape that extends rearward as the duct 90 extends upward. An upper end side of the duct 90 is provided to pass through the end portion of the heater insulator 56 that overlaps in the vehicle front-rear direction and the end portions of the connector block 17 and the facing portion 55. A lower end side of the duct 90 is fixed to the main panel 61.

The duct 90 connects the space 62s described above and the flow path P. By the duct 90, the air flowing toward the lower side of the power storage device 10 can be introduced into the flow path P. Since the temperature of the air is relatively low, the total amount of the low-temperature air flowing through the flow path P can be increased.

As described above, in the vehicle 1 according to Embodiment 1, in a configuration in which the exhaust pipe 100 is disposed adjacent to the second side wall portion 11B of the accommodation case, the flow path defining portion 50 is provided outside the accommodation case and extends along a portion of the joint portion 14 positioned on the front wall portion 11C side. In addition, the air inlet portion 50a of the flow path P defined by the flow path defining portion 50 is positioned at a position farther from the exhaust pipe 100 (more specifically, the second extending portion 102) than the air outlet portion 50b.

Therefore, air having a low temperature and being far from the exhaust pipe 100 can be taken in from the air inlet portion 50a and sent to the second side wall portion 11B through the flow path P. In this case, since the air having a low temperature flows along the portion of the joint portion 14 positioned on the front wall portion 11C side, the peripheral temperature of the joint portion 14 can be reduced. In addition, by blowing air having a low temperature to the second side wall portion 11B side, the peripheral temperature of the second side wall portion 11B side close to the exhaust pipe 100 can be reduced. Since the seal member 15 is disposed in the joint portion 14, by reducing the peripheral temperature of the accommodation case, the effect of heat from the exhaust pipe 100 on the seal member 15 can be reduced.

### Modification 1

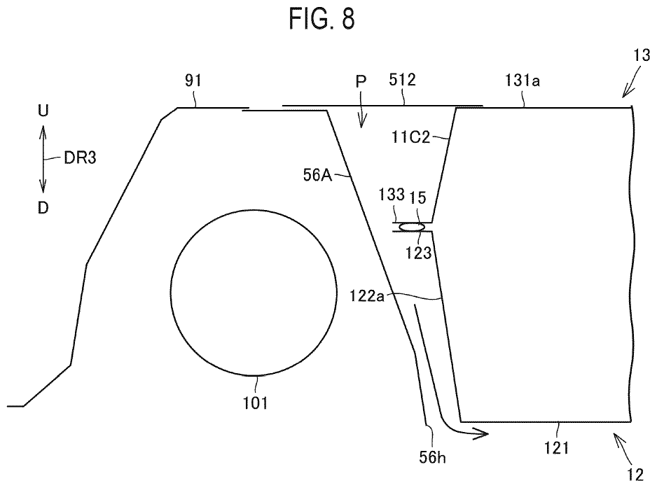

FIG. 8 is a schematic cross-sectional view for describing a structure of a heater insulator according to Modification 1. A heater insulator 56A according to Modification 1 will be described with reference to FIG. 8.

As shown in FIG. 8, an opening portion 56h may be provided at a bottom portion of the heater insulator 56A. Even when configured as described above, a vehicle equipped with the heater insulator 56A can obtain substantially the same effect as the vehicle 1 according to Embodiment 1.

In addition, as described above, since the opening portion 56h is provided, the periphery of the opening portion 56h becomes a negative pressure region due to the air flowing below the power storage device 10. Then, as indicated by an arrow in FIG. 8, a part of the air in the flow path P can be discharged from the flow path P positioned between the heater insulator 56A and the recessed portion 11C2.

### Embodiment 2

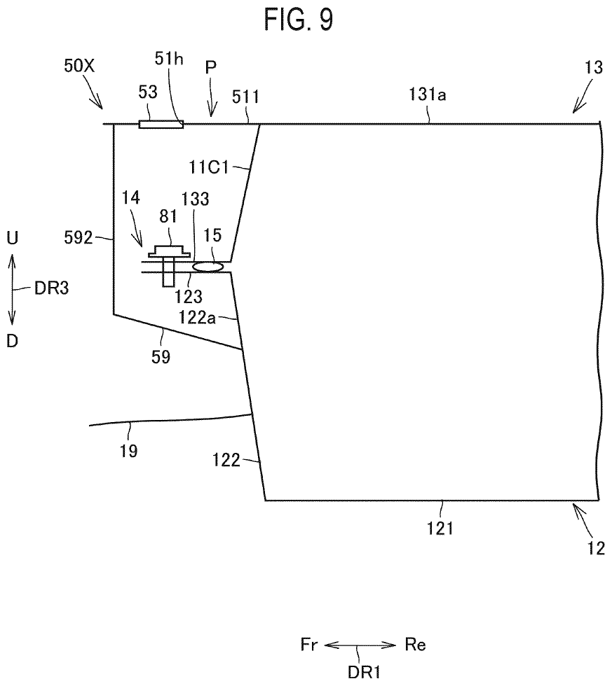

FIG. 9 is a schematic cross-sectional view showing a structure of an accommodation case of the power storage device on a front surface side in the vehicle according to Embodiment 2.

As shown in FIG. 9, the vehicle according to Embodiment 2 differs in the configuration of the flow path defining portion 50X compared with the vehicle according to Embodiment 1. The other configurations are substantially the same.

In Embodiment 2, since the function of the connector block is incorporated into the front wall portion of the lower casing 12, the connector block 17 is not provided as compared with Embodiment 1. Therefore, a facing member 59 is directly connected to a front surface of the lower casing 12, and the facing member 59 constitutes a part of the flow path defining portion 50X in place of the facing portion 55 according to Embodiment 1.

The facing member 59 may be constituted by, for example, a metal member such as aluminum or SUS. The facing member 59 is connected to the front surface of the lower casing 12 by welding or the like. The facing member 59 includes a first portion and a second portion 592. The first portion extends upward as the first portion extends forward from the front wall portion 11C. The second portion 592 extends upward from a front end of the first portion.

A lower side of a space positioned between the second portion 592 and the first portion 11C1 is closed by the first portion. An upper side of the space positioned between the second portion 592 and the first portion 11C1 is closed by the first plate portion 511.

A region surrounded by the first plate portion 511, the facing member 59, and the front wall portion 11C (more specifically, the first portion 11C1) facing the facing member 59 serves as a part of the flow path P.

Even when configured as described above, the vehicle according to Embodiment 2 can obtain substantially the same effect as the vehicle 1 according to Embodiment 1. In Embodiment 2, the plate is provided integrally with the upper cover 13. That is, an upper wall portion of the upper cover 13 has a shape that protrudes forward from a joint portion between the upper wall portion and the front wall portion of the upper cover 13. As described above, by providing the plate integrally with the upper cover 13, the number of components can be further reduced.

### Embodiment 3

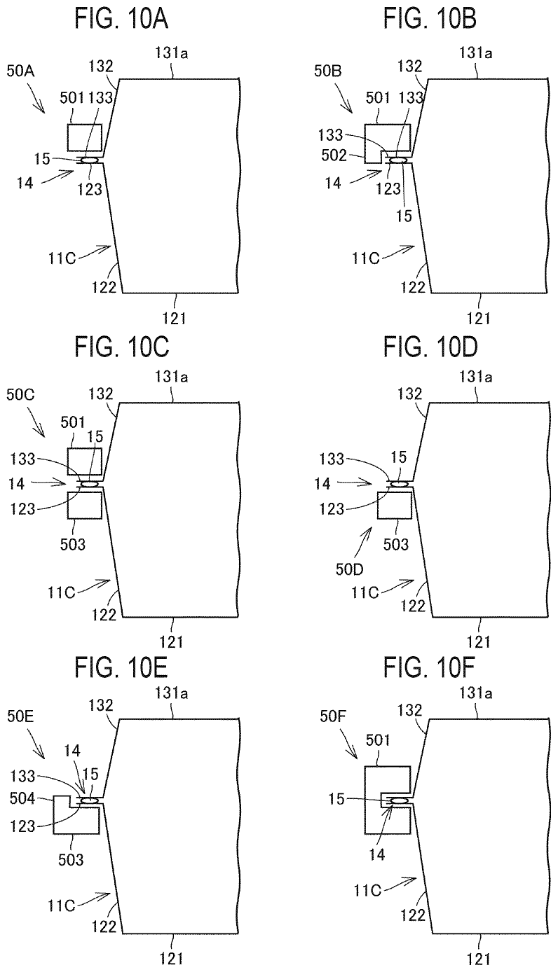

FIGS. 10A to 10F are views showing a variation of a flow path defining portion disposed forward of the power storage device in the vehicle according to Embodiment 3.

FIGS. 10A to 10F are views showing a first variation to a sixth variation of the flow path defining portion. In each of the first variation to the sixth variation, the configurations of the flow path defining portions 50A to 50F are different from each other, but all of the flow path defining portions 50A to 50F are constituted by one or two tubular members. In addition, all of the flow path defining portions 50A to 50F are disposed forward of the accommodation case (more specifically, forward of the front wall portion 11C) and extend along the portion of the joint portion 14 positioned on the front wall portion 11C.

As shown in FIG. 10A, the flow path defining portion 50A in the first variation is constituted by one tubular member 501. The tubular member 501 is disposed above the portion of the joint portion 14 positioned on the front wall portion 11C.

As shown in FIG. 10B, the flow path defining portion 50B in the second variation is constituted by one tubular member 501. The tubular member 501 has a substantially L-like shape. A protruding portion 502 that extends downward is provided on a front end side of the tubular member 501. The protruding portion 502 faces the portion of the joint portion 14 positioned on the front wall portion 11C in the vehicle front-rear direction. That is, the protruding portion 502 is positioned forward of the portion of the joint portion 14 positioned on the front wall portion 11C.

As shown in FIG. 10C, the flow path defining portion 50C in the third variation is constituted by two tubular members 501, 503. The tubular member 501 is disposed above the portion of the joint portion 14 positioned on the front wall portion 11C. The tubular member 503 is disposed below the portion of the joint portion 14 positioned on the front wall portion 11C.

As shown in FIG. 10D, the flow path defining portion 50D in the fourth variation is constituted by one tubular member 503. The tubular member 503 is disposed below the portion of the joint portion 14 positioned on the front wall portion 11C.

As shown in FIG. 10E, the flow path defining portion 50E in the fifth variation is constituted by two tubular members 503. A protruding portion 504 that extends upward is provided on a front end side of the tubular member 503. The protruding portion 504 faces the portion of the joint portion 14 positioned on the front wall portion 11C in the vehicle front-rear direction. That is, the protruding portion 504 is positioned forward of the portion of the joint portion 14 positioned on the front wall portion 11C.

As shown in FIG. 10F, the flow path defining portion 50F in the sixth variation is constituted by one tubular member 501. The tubular member 501 has a substantially C-like shape. The tubular member 501 is provided to surround the periphery of the portion of the joint portion 14 positioned on the front wall portion 11C.

As described above, even in the vehicle in which the flow path defining portions 50A to 50F are disposed forward of the front wall portion 11C, substantially the same effect as the vehicle 1 according to Embodiment 1 can be obtained.

As described above, the embodiments disclosed herein are illustrative in all respects and are not restrictive. The scope of the present disclosure is indicated by the claims, and is intended to include all modifications within the meaning and scope equivalent to the scope of the claims.

What is claimed is:

1. A vehicle comprising:
a power storage device; and
an exhaust pipe that extends along a vehicle front-rear direction, a part of the exhaust pipe being disposed on a side of the power storage device, wherein:
the power storage device includes an accommodation case including an upper cover and a lower casing, and a seal member configured to seal a joint portion between the upper cover and the lower casing;
the accommodation case includes a front wall portion and a rear wall portion that are spaced apart from each other in the vehicle front-rear direction, and a first side wall portion and a second side wall portion that are spaced apart from each other in a vehicle width direction;
the exhaust pipe is disposed on the second side wall portion side;
the vehicle further includes a flow path defining portion provided outside the accommodation case, the flow path defining portion being configured to define a flow path that extends along a portion of the joint portion positioned on the front wall portion side and that has an air inlet portion and an air outlet portion; and
the air inlet portion is positioned at a position farther from the exhaust pipe than the air outlet portion.

2. The vehicle according to claim 1, wherein:
a connector block is provided on the lower casing side of the front wall portion;
the connector block is provided with a facing portion that protrudes upward from the portion of the joint portion positioned on the front wall portion side and that faces the front wall portion in the vehicle front-rear direction;
the flow path defining portion includes a first plate portion that is configured to connect the facing portion and the upper cover, and that covers a space between the facing portion and the front wall portion, and the facing portion; and
a region surrounded by the first plate portion, the facing portion, and the front wall portion facing the facing portion serves as the flow path.

3. The vehicle according to claim 1, wherein:
a facing member that protrudes upward from the portion of the joint portion positioned on the front wall portion side and that faces the front wall portion in the vehicle front-rear direction is provided on a front surface of the lower casing;
the flow path defining portion includes a first plate portion that is configured to connect the facing member and the upper cover, and that covers a space between the facing member and the front wall portion, and the facing member; and
a region surrounded by the first plate portion, the facing member, and the front wall portion facing the facing member serves as the flow path.

4. The vehicle according to claim 2, further comprising a floor panel, wherein:
the power storage device is disposed below the floor panel; and
the vehicle further includes a duct configured to take in air flowing toward a lower side of the power storage device into the flow path.

5. The vehicle according to claim 3, further comprising a floor panel, wherein:
the power storage device is disposed below the floor panel; and
the vehicle further includes a duct configured to take in air flowing toward a lower side of the power storage device into the flow path.

6. The vehicle according to claim 4, wherein:
the front wall portion includes a recessed portion recessed rearward on the second side wall portion side;
the exhaust pipe includes a first extending portion that extends along the recessed portion in the vehicle width direction, and a second extending portion that is connected to the first extending portion and extends rearward of the vehicle along the second side wall portion;
the flow path defining portion further includes a heater insulator that is disposed between the first extending portion and the recessed portion and that faces the recessed portion from a front side of the vehicle, and a second plate portion configured to connect the heater insulator and the upper cover, and covers a space between the heater insulator and the recessed portion; and
a region surrounded by the second plate portion, the heater insulator, and the recessed portion serves as the flow path.

7. The vehicle according to claim 5, wherein:
the front wall portion includes a recessed portion recessed rearward on the second side wall portion side;
the exhaust pipe includes a first extending portion that extends along the recessed portion in the vehicle width direction, and a second extending portion that is connected to the first extending portion and extends rearward of the vehicle along the second side wall portion;
the flow path defining portion further includes a heater insulator that is disposed between the first extending portion and the recessed portion and that faces the recessed portion from a front side of the vehicle, and a second plate portion configured to connect the heater insulator and the upper cover, and covers a space between the heater insulator and the recessed portion; and
a region surrounded by the second plate portion, the heater insulator, and the recessed portion serves as the flow path.

8. The vehicle according to claim 1, wherein the flow path defining portion is constituted by a tubular member disposed forward of the accommodation case.
